(19) United States
(12) Patent Application Publication
(10) Pub. No.: US 2007/0216119 A1
(43) Pub. Date: Sep. 20, 2007

(54) Cart assembly having improved support structure

(75) Inventor: Jeffrey R. Cosgrove, Zionsville, IN (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Sonny Scaffolds, Inc., Indianapolis, IN (US)

(21) Appl. No.: 11/375,779

(22) Filed: Mar. 15, 2006

(51) Int. Cl. B62B 1/00

(52) U.S. Cl. 280/79.7

(57) ABSTRACT

A cart assembly includes a generally M-shaped support member having (i) a first arcuate segment that defines a first apex portion, and (ii) a second arcuate segment that defines a second apex portion. The cart assembly also includes a first wheel base attached to the generally M-shaped support member, and a first caster assembly secured to the first wheel base. The cart assembly additionally includes a second wheel base attached to the generally M-shaped support member, and a second caster assembly secured to the second wheel base. Moreover, the cart assembly includes a handle assembly having (i) a first linearly upstanding segment, and (ii) a second linearly upstanding segment. In addition, the cart assembly includes a cross member connected to both the first linearly upstanding segment and the second linearly upstanding segment. The cart assembly further includes (i) a first brace connected to both the cross member and the first apex portion of the generally M-shaped support member, and (ii) a second brace connected to both the cross member and second apex portion of the generally M-shaped support member.

### BACKGROUND

The present disclosure relates generally to carts, and more particularly to carts that may be used to transport drywall sheets to various locations at a work site.

Carts are commonly used at worksites for moving items such as drywall sheets from one location to another. Structures at a worksite, such as walls, define paths through which the carts must travel. Worksites, such as residential and commercial worksites, commonly have tight paths that include many corner structures created by walls. These tight paths create challenges for the worker that is manipulating the cart through the paths. Indeed, if the cart comes into contact with a corner structure, damage to the structure may occur.

In an effort to aid the worker, some carts have been designed with a relief area on one side of the cart to enable the cart to make tighter turns. One example of such a cart is disclosed in U.S. Pat. No. 2,466,149 in which the cart possesses a V-shaped relief area on one side of the cart. However, as a result of providing the relief area, the cart possesses sharp transitions in its support structure that may damage corner structures and other wall structures. Another example of a cart with a relief area is available from Sonny Scaffolds, Inc. of Indianapolis, Ind. as Model No. SDC-2 Residential Drywall Cart. However, the configuration of the support structure of this cart also possesses abrupt transitions in its support structure that may tend to be rough on wall structures upon contact with the cart.

What is needed therefore is a cart assembly that possesses a configuration that results in less damage to walls and other structures when the cart is being moved around at a worksite. What is also needed is a cart assembly having an improved design.

### SUMMARY

In accordance with one embodiment, there is provided a cart assembly that includes a generally M-shaped support tube configured to possess (i) a first linearly extending lateral segment, (ii) a second linearly extending lateral segment spaced apart from the first linearly extending lateral segment, (iii) a first linearly extending intermediate segment interposed between the first linearly extending lateral segment and the second linearly extending lateral segment, (iv) a second linearly extending intermediate segment interposed between the first linearly extending lateral segment and the second linearly extending lateral segment, (v) a first arcuate segment connecting the first linearly extending lateral segment to the first linearly extending intermediate segment, (vi) a second arcuate segment connecting the first linearly extending intermediate segment to the second linearly extending intermediate segment, and (vii) a third arcuate segment connecting the second linearly extending intermediate segment to the second linearly extending lateral segment. The cart assembly further includes (i) a first wheel base attached to the first linearly extending lateral segment and the first arcuate segment, (ii) a first caster assembly secured to the first wheel base, (iii) a second caster assembly secured to the first wheel base, the second caster assembly being spaced apart from the first caster assembly, (iv) a second wheel base attached to the second linearly extending lateral segment and the third arcuate segment, (v) a third caster assembly secured to the second wheel base, (vi) a fourth caster assembly secured to the second wheel base, the fourth caster assembly being spaced apart from the third caster assembly, (vii) a generally U-shaped handle assembly having (a) a first linearly upstanding segment, (b) a second linearly upstanding segment, and (c) an intermediate portion connected to both the first linearly upstanding portion and the second linearly upstanding portion, (viii) a cross member connected to both the first linearly upstanding segment and the second linearly upstanding segment, (ix) a first brace connected to both the first arcuate segment of the support tube and the cross member, and (x) a second brace connected to both the third arcuate segment of the support tube and the cross member.

Pursuant to another embodiment, there is provided a cart assembly that includes a generally M-shaped support member having (i) a first arcuate segment that defines a first apex portion, and (ii) a second arcuate segment that defines a second apex portion. The cart assembly also includes a first wheel base attached to the generally M-shaped support member, and a first caster assembly secured to the first wheel base. The cart assembly additionally includes a second wheel base attached to the generally M-shaped support member, and a second caster assembly secured to the second wheel base. Moreover, the cart assembly includes a handle assembly having (i) a first linearly upstanding segment, and (ii) a second linearly upstanding segment. In addition, the cart assembly includes a cross member connected to both the first linearly upstanding segment and the second linearly upstanding segment. The cart assembly further includes (i) a first brace connected to both the cross member and the first apex portion of the generally M-shaped support member, and (ii) a second brace connected to both the cross member and second apex portion of the generally M-shaped support member.

According to still another embodiment, there is provided a cart assembly that includes a support structure configured to possess (i) a first linearly extending lateral segment, (ii) a second linearly extending lateral segment spaced apart from the first linearly extending lateral segment, (iii) a first linearly extending intermediate segment interposed between the first linearly extending lateral segment and the second linearly extending lateral segment, (iv) a second linearly extending intermediate segment interposed between the first linearly extending lateral segment and the second linearly extending lateral segment, (v) a first arcuate segment connected to both the first linearly extending lateral segment and the first linearly extending intermediate segment, (vi) a second arcuate segment connected to both the first linearly extending intermediate segment and the second linearly extending intermediate segment, and (vii) a third arcuate segment connected to both the second linearly extending intermediate segment and the second linearly extending lateral segment. The cart assembly further includes (i) a handle assembly connected to the support structure, (ii) a tray supported by the support structure, and (iii) a wheel assembly attached to the support structure. The first linearly extending lateral segment and the first linearly extending intermediate segment are positioned in relation to each other so as to define an angle Θ1. The second linearly extending lateral segment and the second linearly extending intermediate segment are positioned in relation to each other so as to define an angle Θ2. The first linearly extending intermediate segment and the second linearly extending intermediate segment are positioned in relation to each other so as to define an angle Θ3. And 30°≦Θ1≦50°, and 30°≦Θ2≦50°, and 60°≦Θ3<100°.

### BRIEF DESCRIPTION OF THE DRAWINGS

FIG. 1 is a perspective view of a cart assembly of the present disclosure;

FIG. 2 is a perspective view of a base portion of the cart assembly of FIG. 1, with its UHMW platform shown removed;

FIG. 3 is a side elevational view of the cart assembly of FIG. 1, with its caster assemblies shown removed;

FIG. 4 is a top elevational view of the cart assembly of FIG. 1, with its caster assemblies shown removed;

FIG. 5 is a perspective view of a support tube of the cart assembly of FIG. 1;

FIG. 6 is a perspective view of a generally M-shaped support structure of the cart assembly of FIG. 1;

FIG. 7 is a top elevational view of the generally M-shaped support structure of FIG. 6;

FIG. 8 is a front elevational view of the generally M-shaped support structure of FIG. 6;

FIG. 9 is a side elevational view of the generally M-shaped support structure of FIG. 6;

FIG. 10 is a perspective view of a wheel base of the cart assembly of FIG. 1;

FIG. 11 is a top elevational view of the wheel base of FIG. 10;

FIG. 12 is a perspective view of another wheel base of the cart assembly of FIG. 1;

FIG. 13 is a top elevational view of the wheel base of FIG. 12;

FIG. 14 is a perspective view of a tray of the cart assembly of FIG. 1;

FIG. 15 is a side elevational view of the tray of FIG. 14;

FIG. 16 is a front elevational view of the tray of FIG. 14; and

FIG. 17 is a top elevational view of the tray of FIG. 14.

### DESCRIPTION OF THE PREFERRED EMBODIMENT

While the cart assembly described herein is susceptible to various modifications and alternative forms, a specific embodiment thereof has been shown by way of example in the drawings and will herein be described in detail. It should be understood, however, that there is no intent to limit the cart assembly to the particular form disclosed, but on the contrary, the intention is to cover all modifications, equivalents, and alternatives falling within the spirit and scope of the invention as defined by the appended claims.

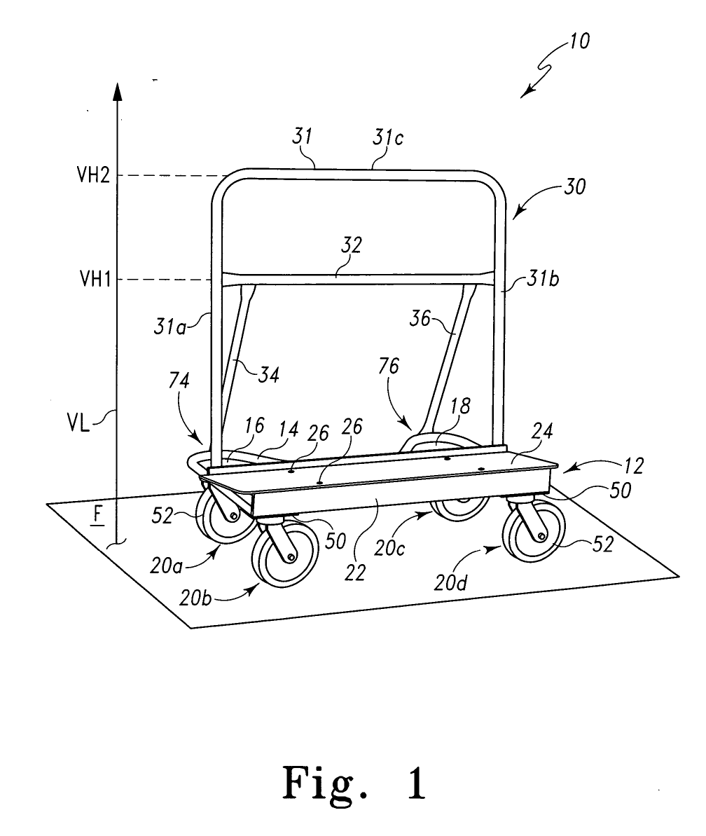

Referring now to FIG. 1, there is shown a cart assembly 10 that is configured to transport drywall sheets to various locations at a work site. While the cart assembly is well adapted for this particular task, the cart assembly 10 may be used to transport other items such as doors, panels, bedding, and other furniture and things.

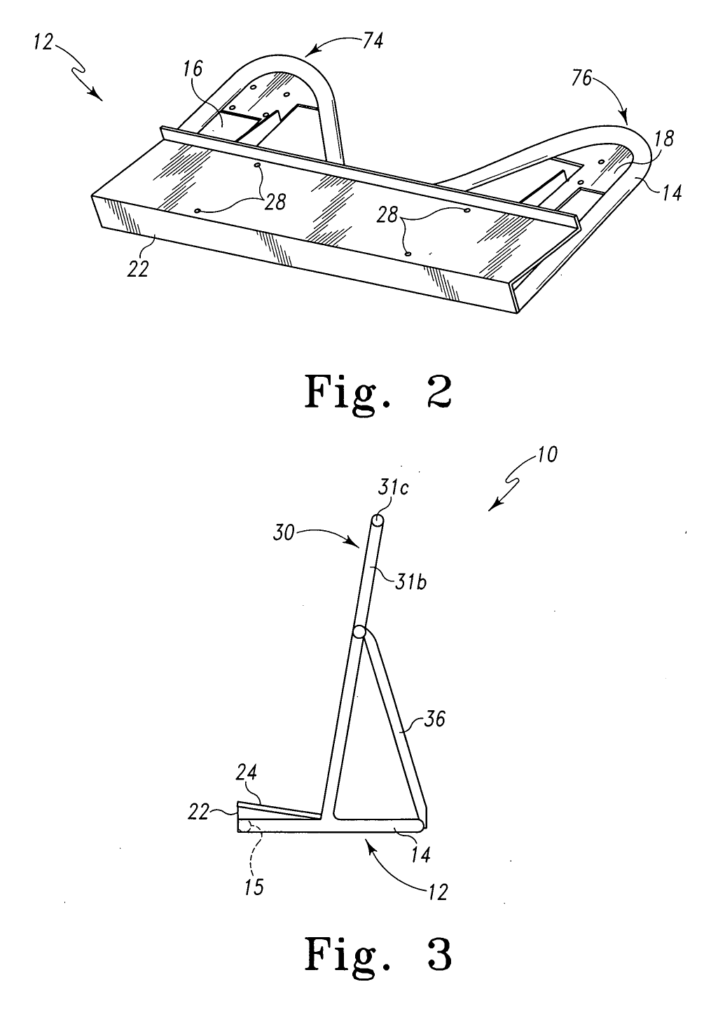

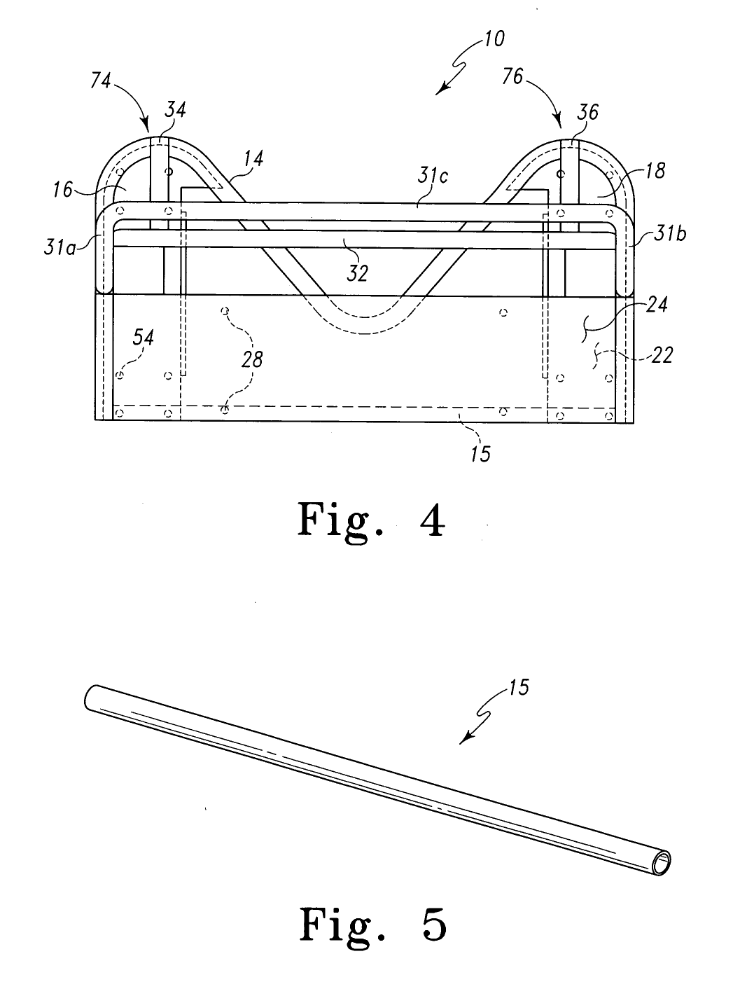

The cart assembly 10 includes a base portion 12 (see also FIG. 2). The base portion 12 includes a generally M-shaped support structure 14. The base portion 12 further includes a first wheel base 16 and a second wheel base 18 which are each secured to the support structure 14 by, for example, welding. The base portion 12 also includes a support tube 15 that is secured in relation to the support structure 14 as shown in FIG. 4. The support tube 15 may be secured to the support structure 14 in one of any number of ways, such as by welding. The cart assembly 10 further includes a plurality of caster assemblies 20a-20d that are attached to the first and second wheel bases 16, 18. In particular, the caster assemblies 20a, 20b are bolted to the first wheel base 16, while the caster assemblies 20c, 20d are bolted to the second wheel base 18.

The cart assembly 10 further includes a tray 22 that is positioned over the support structure 14. The tray 22 is secured to the support structure 14 by, for example, welding. The tray 22 defines a generally planar top support surface. A platform 24 is positioned on the tray 22 as shown in FIG. 1. The platform 24 is made from a Ultra-High Molecular Weight (UHMW) polyethylene material. The platform 24 is bolted to the tray 22 with bolts 26 advanced through openings 28 defined in the tray 22. The platform also defines a generally planar top support surface.

The cart assembly 10 additionally includes a handle assembly 30 that includes a U-shaped portion 31 and a horizontally-oriented cross member 32. The U-shaped portion 31 includes a first upstanding member 31a and a second upstanding member 31b that are spaced apart from each other. The U-shaped portion further includes an intermediate portion 31c that connects the first upstanding member 31a to the second upstanding member 31b. The cross member 32 is connected to both the first upstanding member 31a and the second upstanding member 31b as shown in FIG. 1 by, for example, welding. Prior to attaching the ends of the cross member 32 as shown in FIG. 1, each end is flattened or smashed to form a flat attachment portion.

It should be appreciated that the cross member 32 is positioned at a first vertical height VH1, while the intermediate portion 31c is positioned at a second vertical height VH2, and VH1≦VH2 when the cart assembly is supported on a floor F in its normal operating position. FIG. 1 shows a vertical line VL indicating the vertical heights VH1, VH2 in relation to the floor F on which the cart assembly 10 is supported during its normal operation.

The cart assembly 10 also includes a brace 34 that is connected to both the support structure 14 and the cross member 32 as shown in FIG. 1. The cart further includes another brace 36 that is connected to both the support structure 14 and the cross member 34 as shown in FIG. 1. The braces 34, 36 are secured to the support structure 14 and the cross member by welding, for example. Prior to attaching the ends of the braces 34, 36 as shown in FIGS. 1, 3, and 4, each end of the braces 34, 36 is flattened or smashed to form a flat attachment portion.

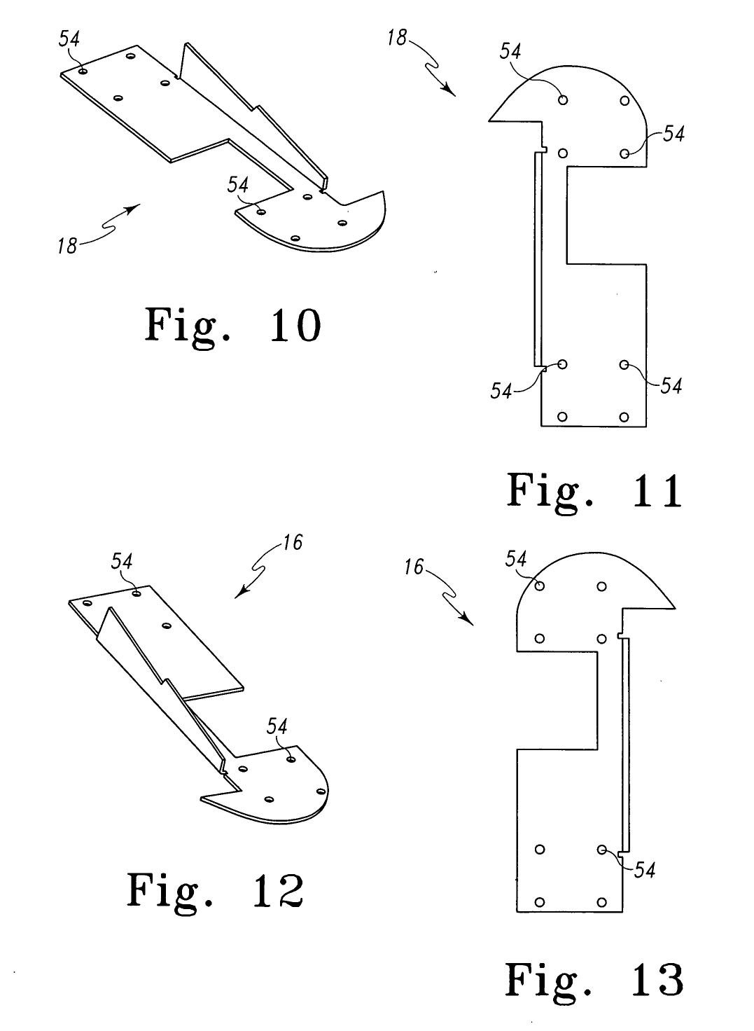

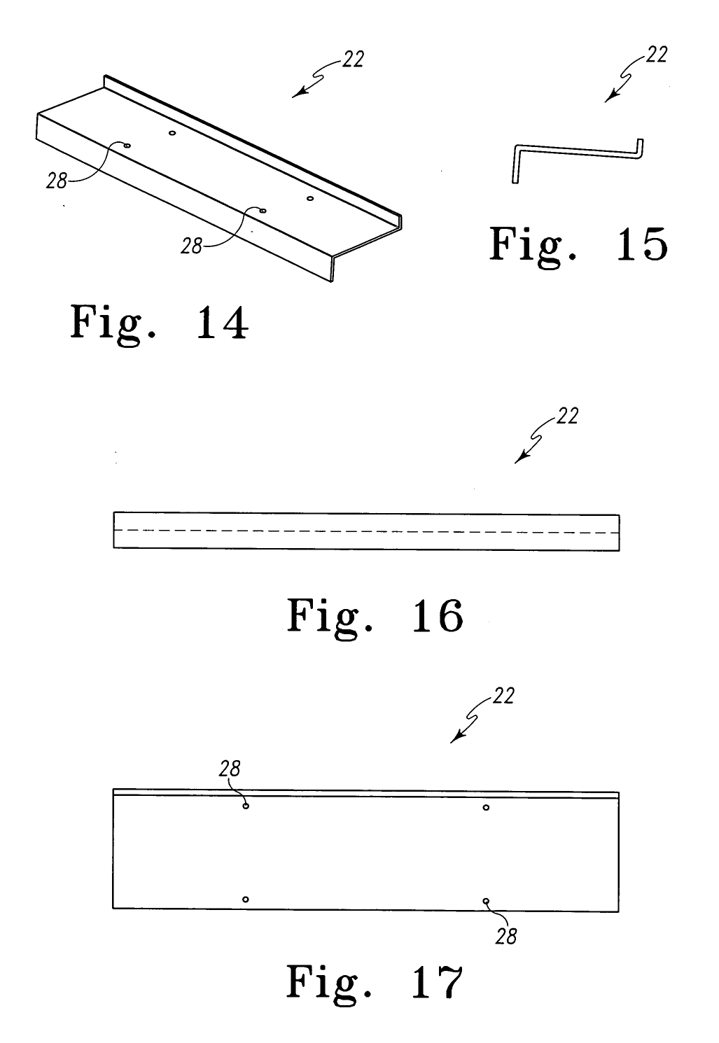

Each caster assembly 20a-20d includes a mount 50 and a wheel 52 (see FIG. 1) that is rotatably secured to the mount 50 as is well known in the art. Each mount 50 of the caster assemblies 20a-20b is secured to the first wheel base 16 by bolting, and each mount 50 of the caster assemblies 20c-20d is secured to the second wheel base 18 by bolting. To this end, the first wheel base 16 (see FIGS. 12-13) and the second wheel base 18 (FIGS. 10-11) have defined therein openings 54 to receive bolts used to attach the caster assemblies 20a-20d to the wheel bases 16, 18.

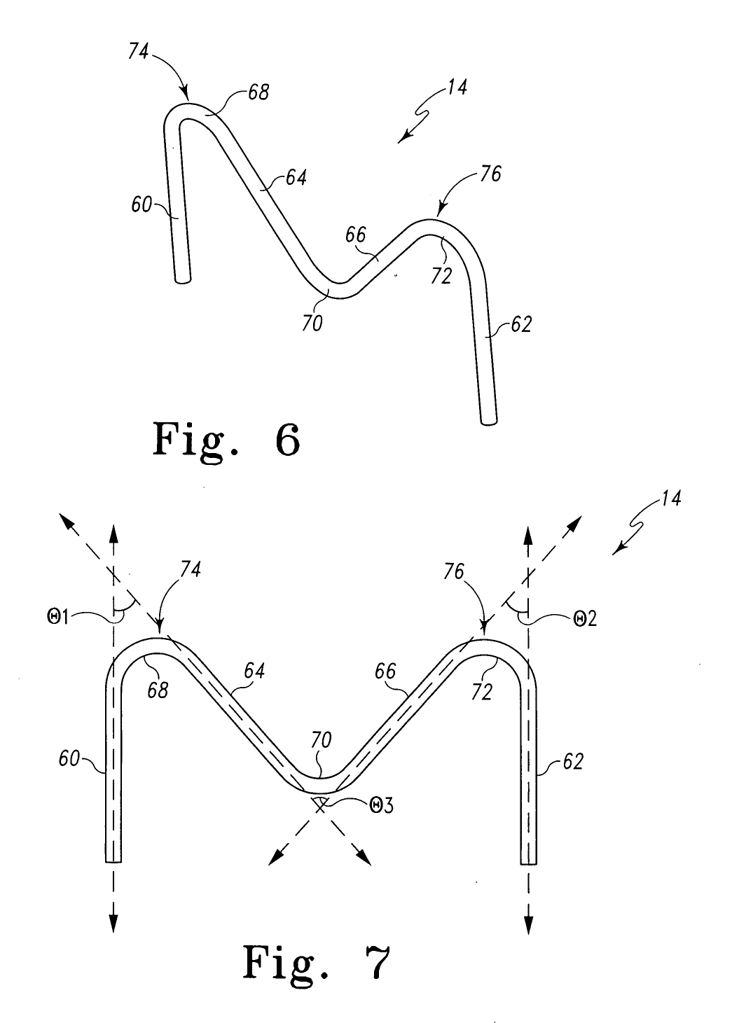

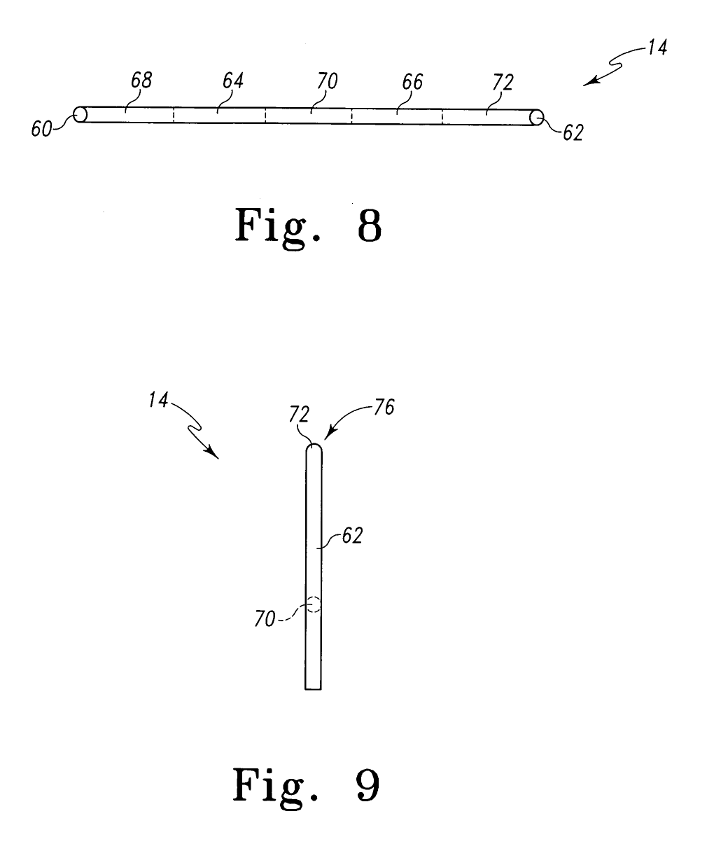

The generally M-shaped support structure 14 is shown in more detail in FIGS. 6-9. The support structure 14 includes a single tube that is bent or otherwise formed generally into the shape of a letter M. As shown in FIG. 7, the support structure 14 includes (i) a linearly extending lateral segment 60, (ii) a linearly extending lateral segment 62 spaced apart from the linearly extending lateral segment 60, (iii) a linearly extending intermediate segment 64 interposed between the linearly extending lateral segment 60 and the linearly extending lateral segment 62, (iv) a linearly extending intermediate segment 66 interposed between the linearly extending lateral segment 60 and the linearly extending lateral segment 62, (v) an arcuate segment 68 connecting the linearly extending lateral segment 60 to the linearly extending intermediate segment 64, (vi) an arcuate segment 70 connecting the linearly extending intermediate segment 64 to the linearly extending intermediate segment 66, and (vii) an arcuate segment 72 connecting the linearly extending intermediate segment 66 to the linearly extending lateral segment 62. As shown in FIGS. 6 and 7, the arcuate segment 68 defines a first apex portion 74, while the arcuate segment 72 defines a second apex portion 76. As shown in FIGS. 1 and 4, the lower end of the brace 34 is attached to the apex portion 74 of the support structure 14, while the upper end of the brace 34 is attached to the cross member 32. Similarly, the lower end of the brace 36 is attached to the apex portion 76 of the support structure 14, while the upper end of the brace 36 is attached to the cross member 32.

As shown in FIG. 7, the linearly extending lateral segment 60 and the linearly extending intermediate segment 64 are positioned in relation to each other so as to define an angle Θ1, wherein 30°≦Θ1≦50°. Also, the linearly extending lateral segment 62 and the linearly extending intermediate segment 66 are positioned in relation to each other so as to define an angle Θ2, wherein 30°≦Θ2≦50°. As further shown in FIG. 7, the linearly extending intermediate segment 64 and the linearly extending intermediate segment 66 are positioned in relation to each other so as to define an angle Θ3, wherein 60°≦Θ3≦100°. Additionally, the linearly extending lateral segment 60 is arranged to be parallel to the linearly extending lateral segment 62 as shown in FIG. 7.

There is a plurality of advantages arising from the various features of the embodiment of the cart assembly 10 described herein. It will be noted that alternative embodiments the cart assembly may not include all of the features described yet still benefit from at least some of the advantages of such features. Those of ordinary skill in the art may readily devise their own implementations of the cart assembly that incorporate one or more of the features of the cart assembly and fall within the spirit and scope of the present invention as defined by the appended claims.

For example, while the support structure 14 is disclosed as including a single tube that is bent or otherwise formed generally into the shape of a letter M and has many advantages as a result, the support structure 14 may be formed of multiple tubes secured together that collectively form the general shape of the letter M and still achieves some of the advantages of the cart assembly 10 described herein. In addition, while the support structure 14 includes a tube having a circular cross-sectional shape and has many advantages thereby, the support structure 14 may be formed from a support structure that does not possess a circular cross-sectional shape, but rather possesses another cross-sectional shape such as a square or rectangle or oval and still achieves certain of the advantages of the cart assembly 10 described herein.

What is claimed is:

1. A cart assembly, comprising:
a generally M-shaped support tube configured to possess (i) a first linearly extending lateral segment, (ii) a second linearly extending lateral segment spaced apart from said first linearly extending lateral segment, (iii) a first linearly extending intermediate segment interposed between the first linearly extending lateral segment and the second linearly extending lateral segment, (iv) a second linearly extending intermediate segment interposed between the first linearly extending lateral segment and the second linearly extending lateral segment, (v) a first arcuate segment connecting the first linearly extending lateral segment to the first linearly extending intermediate segment, (vi) a second arcuate segment connecting the first linearly extending intermediate segment to the second linearly extending intermediate segment, and (vii) a third arcuate segment connecting the second linearly extending intermediate segment to the second linearly extending lateral segment;
a first wheel base attached to said first linearly extending lateral segment and said first arcuate segment;
a first caster assembly secured to said first wheel base;
a second caster assembly secured to said first wheel base, said second caster assembly being spaced apart from said first caster assembly;
a second wheel base attached to said second linearly extending lateral segment and said third arcuate segment;
a third caster assembly secured to said second wheel base;
a fourth caster assembly secured to said second wheel base, said fourth caster assembly being spaced apart from said third caster assembly;
a generally U-shaped handle assembly having (i) a first linearly upstanding segment, (ii) a second linearly upstanding segment, and (iii) an intermediate portion connected to both the first linearly upstanding portion and the second linearly upstanding portion;
a cross member connected to both said first linearly upstanding segment and said second linearly upstanding segment;
a first brace connected to both said first arcuate segment of said support tube and said cross member; and
a second brace connected to both said third arcuate segment of said support tube and said cross member.

2. The cart assembly of claim 1, further comprising a tray supported on said generally M-shaped support tube, wherein said tray defines a generally planar support surface.

3. The cart assembly of claim 2, further comprising a platform supported on said tray, wherein said platform is made from a UHMW polyethylene material.

4. The cart assembly of claim 1, wherein:
said first linearly extending lateral segment and said first linearly extending intermediate segment are positioned in relation to each other so as to define an angle Θ1,
said second linearly extending lateral segment and said second linearly extending intermediate segment are positioned in relation to each other so as to define an angle Θ2,
30°≦Θ1≦50°, and
30°≦Θ2≦50°.

5. The cart assembly of claim 4, wherein:
said first linearly extending intermediate segment and said second linearly extending intermediate segment are positioned in relation to each other so as to define an angle Θ3, and
60°≦Θ3≦100°.

6. The cart assembly of claim 1, wherein:
said generally M-shaped support tube includes (i) a first apex portion defined by said first arcuate segment, and (ii) a second apex portion defined by said third arcuate segment,
said first brace includes a first lower end and a first upper end,
said second brace includes a second lower end and a second upper end,
said first lower end of said first brace is attached to said first apex portion, and
said second lower end of said second brace is attached to said second apex portion.

7. The cart assembly of claim 6, wherein:
said first upper end of said first brace is attached to said cross member, and
said second upper end of said second brace is attached to said cross member.

8. The cart assembly of claim 7, wherein said first upper end of said first brace is spaced apart from said second upper end of said second brace.

9. The cart assembly of claim 8, wherein:
said cross member is horizontally oriented and positioned at a first vertical height VH1,
said intermediate portion of said U-shaped handle assembly is horizontally oriented and positioned at a second vertical height VH2, and
VH2≦VH2.

10. A cart assembly, comprising:
a generally M-shaped support member having (i) a first arcuate segment that defines a first apex portion, and (ii) a second arcuate segment that defines a second apex portion;
a first wheel base attached to said generally M-shaped support member;
a first caster assembly secured to said first wheel base;
a second wheel base attached to said generally M-shaped support member;
a second caster assembly secured to said second wheel base;
a handle assembly having (i) a first linearly upstanding segment, and (ii) a second linearly upstanding segment;
a cross member connected to both said first linearly upstanding segment and said second linearly upstanding segment;
a first brace connected to both said cross member and said first apex portion of said generally M-shaped support member; and
a second brace connected to both said cross member and second apex portion of said generally M-shaped support member.

11. The cart assembly of claim 1 0, further comprising a tray positioned over said generally M-shaped support member, wherein said tray defines a generally planar support surface.

12. The cart assembly of claim 11, further comprising a platform supported on said tray, wherein said platform is made from a UHMW polyethylene material.

13. The cart assembly of claim 10, wherein:
said first brace includes a first lower end and a first upper end,
said second brace includes a second lower end and a second upper end,
said first lower end of said first brace is attached to said first apex portion,
said second lower end of said second brace is attached to said second apex portion,
said first upper end of said first brace is attached to said cross member, and
said second upper end of said second brace is attached to said cross member.

14. The cart assembly of claim 10, wherein:
said generally M-shaped support member further has (i) a first linearly extending lateral segment connected to said first arcuate segment, and (ii) a second linearly extending lateral segment connected to said second arcuate segment,
said first linearly extending lateral segment and said first linearly extending intermediate segment are positioned in relation to each other so as to define an angle Θ1,
said second linearly extending lateral segment and said second linearly extending intermediate segment are positioned in relation to each other so as to define an angle Θ2,
30°≦Θ1≦50°, and
30°≦Θ2≦50°.

15. The cart assembly of claim 14, wherein:
said generally M-shaped support member further has (i) a first linearly extending intermediate segment connected to said first arcuate segment, and (ii) a second linearly extending intermediate segment connected to said second arcuate segment,
said first linearly extending intermediate segment and said second linearly extending intermediate segment are positioned in relation to each other so as to define an angle Θ3, and
60°≦Θ3≦100°.

16. The cart assembly of claim 15, wherein:
said generally M-shaped support member further has a third arcuate segment connecting said first linearly extending intermediate segment to said first linearly extending intermediate segment.

17. The cart assembly of claim 14, wherein said first linearly extending lateral segment is arranged to be parallel to said second linearly extending lateral segment.

18. A cart assembly, comprising:
a support structure configured to possess (i) a first linearly extending lateral segment, (ii) a second linearly extending lateral segment spaced apart from said first linearly extending lateral segment, (iii) a first linearly extending intermediate segment interposed between the first linearly extending lateral segment and the second linearly extending lateral segment, (iv) a second linearly extending intermediate segment interposed between the first linearly extending lateral segment and the second linearly extending lateral segment, (v) a first arcuate segment connected to both the first linearly extending lateral segment and the first linearly extending intermediate segment, (vi) a second arcuate segment connected to both the first linearly extending intermediate segment and the second linearly extending intermediate segment, and (vii) a third arcuate segment connected to both the second linearly extending intermediate segment and the second linearly extending lateral segment;
a handle assembly connected to said support structure;
a tray supported by said support structure; and
a wheel assembly attached to said support structure,
wherein said first linearly extending lateral segment and said first linearly extending intermediate segment are positioned in relation to each other so as to define an angle Θ1,
wherein said second linearly extending lateral segment and said second linearly extending intermediate segment are positioned in relation to each other so as to define an angle Θ2,
wherein said first linearly extending intermediate segment and said second linearly extending intermediate segment are positioned in relation to each other so as to define an angle Θ3,
wherein 30°≦Θ1≦50°,
wherein 30°≦Θ2≦50°, and
wherein 60°≦Θ3≦100°.

19. The cart assembly of claim 18, further comprising:
a cross member connected to said handle assembly, said cross member being oriented in a horizontal manner;
a first brace connected to both said cross member and said support structure; and
a second brace connected to both said cross member and said support structure.

20. The cart assembly of claim 19, wherein:
wherein said support structure includes (i) a first apex portion defined by said first arcuate segment, and (ii) a second apex portion defined by said third arcuate segment,
said first brace includes a first lower end and a first upper end,
said second brace includes a second lower end and a second upper end,
said first lower end of said first brace is attached to said first apex portion, and
said second lower end of said second brace is attached to said second apex portion.

21. The cart assembly of claim 20, wherein:
said handle assembly includes (i) a first linearly upstanding segment, (ii) a second linearly upstanding segment, and (iii) an intermediate portion connected to both the first linearly upstanding portion and the second linearly upstanding portion, and
said cross member is connected to both said first linearly upstanding segment and said second linearly upstanding segment.

22. The cart assembly of claim 18, wherein said wheel assembly includes:
a first wheel base attached to said first linearly extending lateral segment and said first arcuate segment;
a first caster assembly secured to said first wheel base;
a second caster assembly secured to said first wheel base, said second caster assembly being spaced apart from said first caster assembly;
a second wheel base attached to said second linearly extending lateral segment and said third arcuate segment;
a third caster assembly secured to said second wheel base; and
a fourth caster assembly secured to said second wheel base, said fourth caster assembly being spaced apart from said third caster assembly.

23. The cart assembly of claim 18, wherein said first linearly extending lateral segment is arranged to be parallel to said second linearly extending lateral segment.
